(19) United States
(12) Patent Application Publication
(10) Pub. No.: US 2017/0041978 A1
(43) Pub. Date: Feb. 9, 2017

(54) REMOTE WORKSITE MONITORING SYSTEM

(71) Applicant: Caterpillar Inc., Peoria, IL (US)

(72) Inventor: Ratheesh Radhakrishnan, Chennai (IN)

(73) Assignee: Caterpillar Inc., Peoria, IL (US)

(21) Appl. No.: 15/333,497

(22) Filed: Oct. 25, 2016

(51) Int. Cl. H04W 76/02; B64D 47/08; B64C 39/02

(52) U.S. Cl. CPC H04W 76/027; H04W 76/025; H04W 76/023; B64C 39/024; B64D 47/08; B64C 2201/12; B64C 2201/146

(57) ABSTRACT

A remote worksite monitoring system is provided. The remote worksite monitoring system includes a machine operating at a worksite, The remote worksite monitoring system also includes an Unmanned Aerial Vehicle (UAV) associated with the machine. The UAV includes a control module and a sensor module. The UAV is adapted to fly to a location proximate to an area at which the machine is present. The UAV is adapted to directly communicate with the machine over a first communication network to at least one of receive machine data from the machine and transfer data to the machine when direct communication between the machine and a remote control station cannot be established. Further, the UAV is adapted to transmit the machine data received from the machine to the remote control station over a second communication network.

### TECHNICAL FIELD

The present disclosure relates to a worksite monitoring system, and more particularly to the system for monitoring a number of machines operating at a remote worksite.

### BACKGROUND

A number of different machines operate at a worksite. These machines may communicate with a back office over a wireless communication network, for example cellular or satellite communication. Two way communication between the machines and the back office may take place such that the machine may receive instructions and/or software updates from the back office and the machine may also transfer data related to various machine operating parameters to the back office. However, sometimes the machines may move into zones or areas on the worksite where the communication between the machines and the back office cannot be established. Accordingly, such machines may find it difficult to communicate with the back office until the machine re-enters into a range of communication with respect to the back office.

One solution may involve utilizing peer-to-peer communication between another machine that is still in the range of communication with the back office and the machine that has lost communication ability with the back office. The machine may then indirectly transfer and/or receive information to or from the back office via this proxy machine. Another solution may be to use a distributed transient network to route the information to the back office.

However, these indirect methods of communication may not be as effective and may require costly infrastructure to allow the machines to serve as a slave and a master node in case of the proxy machines, or create additional ad-hoc profiles in case of the distributed transient network. In case of the proxy machine, it may further be difficult to define a storage capacity of the proxy machine, hampering data storage in a situation in which more than one machine attempts to share data with the same proxy machine. Additionally, such profiles may have limited in-built features of security encryption and service discovery, lack of scalability to larger networks, and lack of security features such as MAC filtering and access control. In case of the distributed transient network utilized in connection with a mixed fleet at the worksite, it may be possible for any machine, for example unauthorized machines to tap or sniff valuable machine information which is being routed through a channel.

Further, it may be difficult to estimate and define a frequency of collection of the data by the proxy machine as such communication may be established only when the proxy machine is in a network vicinity of the back office. In case of the distributed transient network, the frequency of communication may be dependent on a connectivity of the distributed transient network. Additionally, it may be difficult for the back office to indirectly pass instructions to the machine via the proxy machine or through the distributed transient network. These approaches may be costly and time consuming, requiring installation and update of software on each of the machines operating at the worksite in order to enable the peer-to-peer communication feature.

Hence, there is a need to provide an improved worksite monitoring system.

### SUMMARY OF THE DISCLOSURE

In one aspect of the present disclosure, a remote worksite monitoring system is provided. The remote worksite monitoring system includes a machine operating at a worksite. The remote worksite monitoring system also includes an Unmanned Aerial Vehicle (UAV) associated with the machine. The UAV includes a control module and a sensor module. The UAV is adapted to fly to a location proximate to an area at which the machine is present. The UAV is adapted to directly communicate with the machine over a first communication network to at least one of receive machine data from the machine and transfer data to the machine when direct communication between the machine and a remote control station cannot be established. Further, the UAV is adapted to transmit the machine data received from the machine to the remote control station over a second communication network.

Other features and aspects of this disclosure will be apparent from the following description and the accompanying drawings.

### BRIEF DESCRIPTION OF THE DRAWINGS

FIG. 1 is a perspective view of an exemplary worksite, according to various concepts of the present disclosure; and

FIG. 2 is a block diagram of a remote worksite monitoring system associated with the worksite of FIG. 1, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

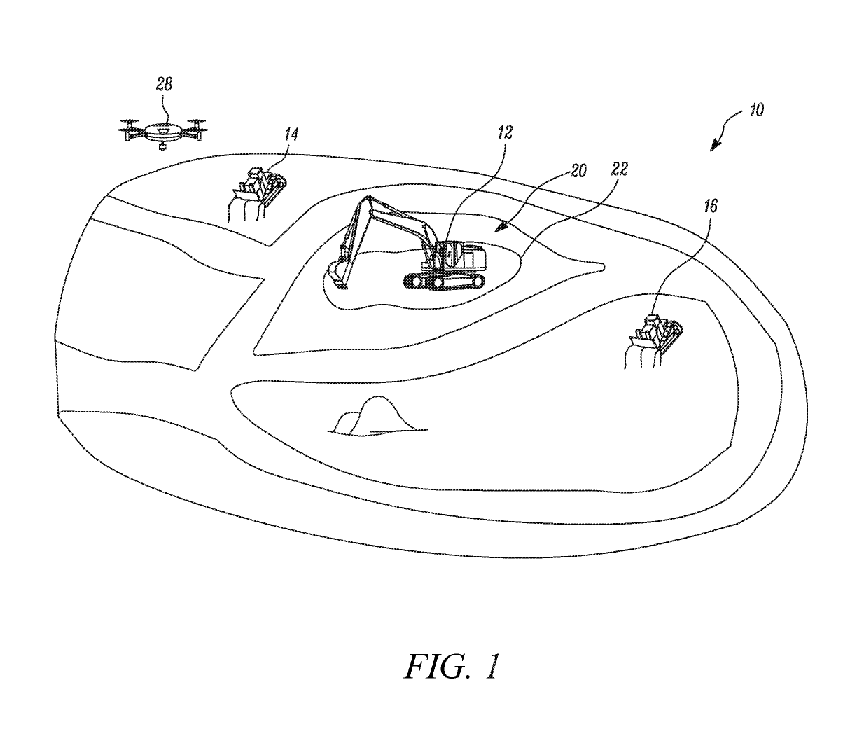

Referring to FIG. 1, a perspective view of an exemplary worksite 10 is illustrated. A number of machines 12, 14, 16 may operate at the worksite 10. A type of the machine 12, 14, 16 may vary based on a type of operation that needs to be performed at the worksite 10. Accordingly, the machines 12, 14, 16 may include, but is not limited to, an excavator, a wheel loader, a backhoe loader, a track type tractor, a shovel, a drilling machine, a hammer, and the like. For explanatory purposes, three machines 12, 14, 16 are shown operating at the worksite 10, however, the number of machines operating at the worksite 10 may vary based on system requirements. The machine 12 is embodied as an excavator and the machines 14, 16 are embodied as track type tractors.

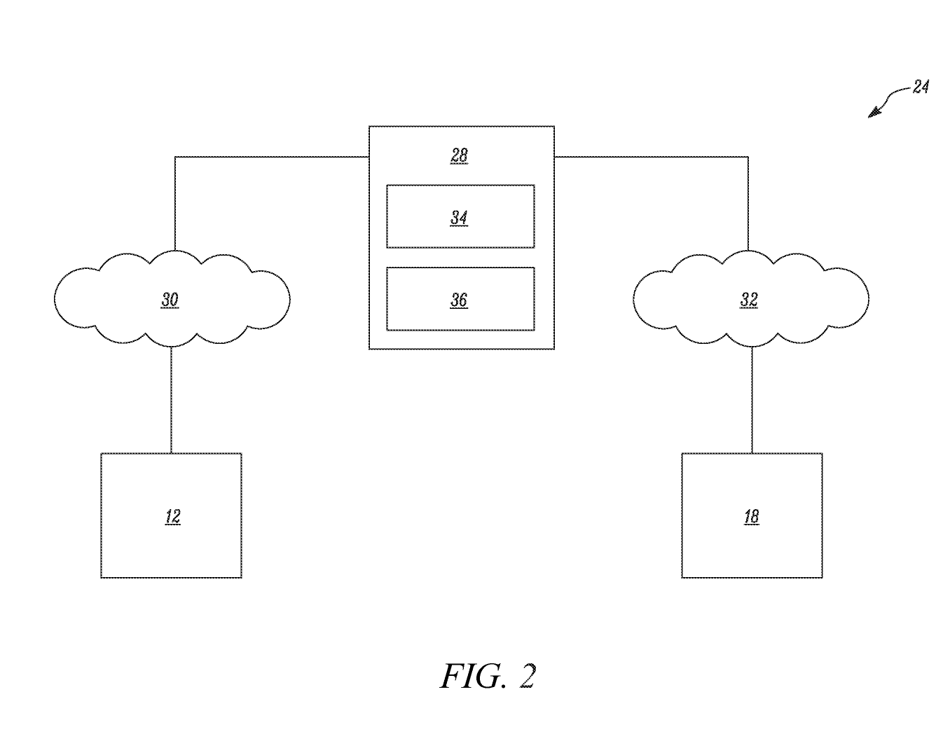

The machines 12, 14, 16 may be autonomous, semi-autonomous, or manually operated. In an example in which the machines 12, 14, 16 are autonomous or semi-autonomous, an operator seated at a remote control station 18 (see FIG. 2) may operate the machines 12, 14, 16. The remote control station 18 may include a base station or a back office that is located at the worksite 10 or at a location that is distant from the worksite 10.

The present disclosure is directed towards a remote worksite monitoring system 24 (see FIG. 2). The remote worksite monitoring system 24 is associated with the worksite 10 and the machines 12, 14, 16 operating at the worksite 10. The remote worksite monitoring system 24 will now be explained in detail. For explanatory purposes, the remote worksite monitoring system 24 will be explained with reference to the machine 12, without any limitations. However, it should be noted that the remote worksite monitoring system 24 can also be utilized in connection with the machines 14, 16, or any other machine that operates at the worksite 10, without limiting the scope of the present disclosure.

Referring to FIGS. 1 and 2, the remote worksite monitoring system 24 includes an Unmanned Aerial Vehicle (UAV) 28. The UAV 28 is communicably coupled to the machine 12 via a first communication network 30. The first communication network 30 may include any known wireless network. For example, the first communication network 30 is a Wi-Fi network, a Wi-Fi Direct network, a radio frequency network, and so on. The UAV 28 is also communicably coupled to the remote control station 18 via a second communication network 32. The second communication network 32 may include, but is not limited to, a wide area network (WAN), a local area network (LAN), an Ethernet, an internet, an intranet, a cellular network, a satellite network, or any other network for transmitting data between the UAV 28 and the remote location 18. In various examples, the second communication network 32 may include a combination of two or more of the aforementioned networks and/or other types of networks known in the art. The second communication network 32 may be implemented as a wired network, a wireless network, or a combination thereof. Further, the data may be transmitted over the second communication network 32 with a network protocol, for example, in an encrypted format, or any other secure format known in the art.

In one example, the UAV 28 may embody a commercial drone that hovers at the worksite 10. The UAV 28 may embody any powered, aerial vehicle without a human pilot aboard that hovers at the worksite 10. The UAV 28 may be autonomous or semi-autonomous remotely operated. For example, the UAV 28 may be operated by the operator at the remote control station 18. The range and altitude of the UAV 28 may be decided based on the requirements at the worksite 10.

The machine 12 may be connected to the remote control station 18 via a direct communication network (not shown). This direct communication network may be any known wireless network such as, a cellular or a satellite communication network. In some situations, when the machine 12 is operating at an area 22 (see FIG. 1) or zone on the worksite 10 at which the machine 12 is unable to establish a direct communication with the remote control station 18 via the direct communication network, the UAV 28 may be used to allow data exchange between the remote control station 18 and the machine 12. Alternatively, the UAV 28 may be used to exchange data with the machine 12 for any other purposes without any limitation.

Referring to FIG. 2, the UAV 28 includes a sensor module 34 and a control module 36. Additionally, the UAV 28 may include additional sub-systems and components such as a position detection module (not shown), for example a global positioning system or inertial measurement unit, and/or an image capturing device (not shown). The UAV 28 also includes a power source (not shown) that powers the UAV 28. The UAV 28 additionally includes a memory device for storing instructions received from the remote control station 18 and information received from the machine 12.

The control module 36 of the UAV 28 may embody a single microprocessor or multiple microprocessors. Numerous commercially available microprocessors can be configured to perform the functions of the control module 36. The control module 36 may include all the components required to run an application such as, for example, a memory, a secondary storage device, and a processor, such as a central processing unit or any other means known in the art. Various other known circuits may be associated with the control module 36, including power supply circuitry, signal-conditioning circuitry, solenoid driver circuitry, communication circuitry, and other appropriate circuitry.

The UAV 28 may receive instructions over the second communication network 32 from the remote control station 18 to fly to the area 22 on the worksite 10 proximate to where the machine 12 is present. In one embodiment, the remote control station 18 may decide a flight path of the UAV 28 based on a location of the machine 12. In one embodiment, an operator may control a positioning of the UAV 28 based on real-time feedback received through a visual feed from the image capturing device on-board the UAV 28. In one example, the visual feed may be used to position the UAV 28 in an environment that is suitable to communicate with more than one machine in the area 22.

Once the UAV 28 is within a range of communication of the first communication network 30, the UAV 28 directly communicates with the machine 12. The UAV 28 is capable of receiving machine data associated with one or more operating parameters of the machine 12. For example, the one or more operating parameters may include an engine speed, a machine speed, a transmission setting, and so on. In one embodiment, the UAV 28 may be used to collect data from more than one machine in the same area 22. Further, the UAV 28 may also transfer data or instructions from the remote control station 18 to the machine 12 over the first communication network 30. In some embodiments, the UAV 28 may facilitate transfer of files required for software upgrade of the machine 12. Accordingly, the UAV 28 is capable of pushing data onto the machine 12 and/or pulling the machine data from the machine 12. The machine data received from the machine 12 may be stored in a database or any other memory storage device present on-board the UAV 28.

After collecting and storing the machine data, the UAV 28 may fly back towards to the remote control station 18 and transfer the machine data collected from the machine 12 to the remote control station 18 via the second communication network 32. In one embodiment, the UAV 28 may collect and store the machine data from a number of the machines in the given geographic area 22.

### INDUSTRIAL APPLICABILITY

The present disclosure provides a system and method for worksite monitoring which may establish an alternate communication path for transfer of data to and from the machine 12 and/or a fleet of the machines 12, 14, 16. This alternate communication path may allow for smooth communication between the remote control station 18 and the machine 12 via the UAV 28 in a situation in which the machine 12 is no longer in the direct communication vicinity of the remote control station 18.

The time interval for data communication, which is data collection from the machine 12 or the time for giving instructions to the machine 12 from the remote control station 18, can be easily defined based on a frequency and duration of the UAV 28 approaching and communicating with the machine 12. The system may be implemented easily by updating or flashing of the UAV 28. Minimum or no software changes are required for the machines 12. Accordingly, time and cost associated with setup and maintenance of this system may be relatively less. This system may be easily deployed in a working environment having the fleet of the machines 12, 14, 16 in which the fleet may include different types of the machines 12, 14, 16. Additionally, in this system the UAV 28 serves as a central access point and the first communication network 30 may include the Wi-Fi infrastructure profile for communication with the machine 12. This infrastructure has in-built security and encryption features and is scalable to form large networks.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A remote worksite monitoring system comprising:
a machine operating at a worksite; and
an Unmanned Aerial Vehicle (UAV) associated with the machine, the UAV including a control module and a sensor module, wherein the UAV is adapted to:
fly to a location proximate to an area at which the machine is present;
directly communicate with the machine over a first communication network to at least one of receive machine data from the machine and transfer data to the machine when direct communication between the machine and a remote control station cannot be established; and
transmit the machine data received from the machine to the remote control station over a second communication network.
